(19) United States
(12) Patent Application Publication
(10) Pub. No.: US 2005/0113059 A1
(43) Pub. Date: May 26, 2005

(54) Homeland security emergency FM radio receiver

(76) Inventor: William Hubbard, Newport News, VA (US)

Correspondence Address: William Hubbard;Plaza E, 7505 River Rd., Newport News, VA, 23607, US

(21) Appl. No.: 10/720,232

(22) Filed: Nov. 25, 2003

(51) Int. Cl. H04B 1/06

(52) U.S. Cl. 455/353; 455/352

(57) ABSTRACT

An Emergency Stereo FM Receiver designed to be part of a Homeland Security Emergency Radio System I envision. A receiver that would remain silent 24 hours a day, day after day, month after month, until an emergency transmission is broadcast by the Department of Homeland Security. A receiver that would take advantage of both the Left and Right channels of the stereo FM signal being transmitted. When turned ON and switched to the Left Stereo channel, the receiver would remain totally silent until the Department of Homeland Security transmits a Warning or Alert. When such a Warning is received, you could then switch to the right channel where you would receive more detailed local information from local authorities as to what is happening and instructions as to what you should do. I also envision additional circuits to improve reliability, as well as additional functions, such as lights to determine the current Alert Condition as well as digital modem capability, etc.

### BACKGROUND OF THE INVENTION

I have been told that the Homeland Security Emergency Radio System that I envision is not patentable as a system. In fact, almost all FM radios in homes and automobiles today would be usable without change during Phase 1 of the Homeland Security Emergency Radio System I envision. This fact, alone, means that almost every person in the United States could enjoy the added security of such an Emergency Radio System on the very first day that this system was put in operation. Phase 1 would last until Homeland Security Emergency Receivers with improved reliability and additional features could be manufactured in sufficient quantity to meet demands. The Homeland Security Emergency receivers I suggest in this patent application offer improved reliability as well as a number of additional features that would offer additional protection to the public as well as efficiency within such a system.

First, to establish a need for the Homeland Security Radio System I envision, let's imagine that at 3:00 AM in the morning terrorists attack a major chemical plant, blowing up tanks containing toxic chemicals that rapidly start spreading deadly fumes over a large area of a major city such as N.Y. How would our local government and police instantly warn and inform the population in and around the area of the attack and what they should do to protect themselves? Our present Homeland Security Emergency Radio System relies on our keeping a radio or TV tuned to a commercial station that is airing its normal programming if we are to be warned. Do you keep a radio or TV blasting 24 hours a day in your home, your place of work, your car, just for the purpose of being warned of such an emergency? Does anyone? Can you imagine the unnecessary loss of life that might follow such an attack due to our government having a warning and communicatons system in place that is so disrupting and annoying that few if anyone use it.

PHASE 1: The Homeland Security Emergency Radio System I envision would be put in place in two stages. During the first stage, Phase 1, using the Homeland Security Emergency System would only require that you have a conventional home, auto or portable FM radio tuned to the station established by the government for Homeland Security “Emergency Warning and Alert” broadcasts in your area. Radios tuned to this frequency would remain totally silent day after day, month after month, except for a thirty second period each day for the sole purpose of tuning the required frequency and setting the volume. Just turn any FM radio you may have ON, tune it to the proper frequency, set the desired volume, and then leave it ON 24 hours a day or whenever you are home. You might tape the tuning dial or push button and volume control. That's all there is to it. Being totally silent, your FM radio will not annoy anyone.

PHASE 2: During the Phase 1 period, the system I envision would transmit the same audio information on both the left and right channels of the Stereo signal. However, with the implementation of Phase 2, conventional FM receivers would have to be replaced with Homeland Security FM Stereo receivers designed to take advantage of both channels of the stereo signal. This would allow the receiver to remain “silent” until a Warning or Alert was broadcast on the Left channel, then allow the user to switch to the Right channel for more detailed local information of the emergency as well as what he should do to protect he and his wife and faimly. The Right Channel would also bring daily National and Local Homeland Security News and Information, 24 hours a day, that would only be disrupted in the event of an Emergency Warning or Alert transmission being-broadcast on the Left channel. Once Phase 2 was implemented, conventional FM radios could receive different transmitted information on both the Left and Right channels at the same time, making them totally unusable. The FM receivers I envision would also include numerous additional features, such as: Pretuned Station Selection, Auto/Search Tuning, Signal Strength Indication, National Alert Condition Lights, Digital Modem Capability, etc., features that I will describe in more detail in the Summary Of The Invention and Brief Description of the Drawings section of this document.

### The Homeland Security Emergency Stations

To establish the Homeland Security Emergency Radio System I envision would require that the government first place Homeland Security Stereo FM stations in every major city in the nation. That five or more Stereo FM frequencies would be commandeered and established as Homeland Security FM radio frequencies. Frequencies such as 101 Mz, 102 MHz, 103 MHz, 104 MHz and 105 MHz might be selected, as they would be easy for the public to remember and could be referred to as Channel 1, 2, 3, 4, and 5. Say that you live where I do, Newport News, Va. Living so close to Portsmouth, Chesapeake, Norfolk and Virginia Beach, each possibly having different emergency information to disperse during a terrorist attack, the different stations might be too close to each other to share a common frequency. However, by allocating five different frequencies, the government could assign the same frequency to more than one of these stations as long as there was a station with a different frequency between the two sharing the same frequency. Although the Portsmouth station might interfere with the Newport News station, it would not likely interfere with the Chesapeake station, which is considerably further away. Remote Homeland Security Emergency Radio Stations might also be placed along major highways to provide emergency instructions and information during an alert or mass evacuation. These stations would be tied into Area Networks that would allow them to be accessed not only by the National Homeland Security Operational Center, but Local Centers manned by local and state government officials, police, military, medical and all others who might be involved.

### SUMMARY OF THE INVENTION AND BRIEF DESCRIPTION OF THE DRAWINGS

The increased reliability of operation and additional features of the Homeland Security Emergency FM Receivers I envision for Phase 2 should become obvious when compared to using conventional FM Radios that could be used during Phase 1. Having been told that I best present one Homeland Security receiver for patent purposes, while realizing there would be various combinations of the different features that might be used in Homeland Security Emergency FM Receivers for the home, the car, as portable receivers, as Walkman type receivers, as minature receivers, no larger than a wrist watch, as well as receivers for various branches of the government that might include a flat screen monitor, very advanced front end tuning and filtering circuits, recording capability, etc., I have chosen to submit, a Homeland Security Emergency FM Receiver that, being a portable, could be used in the home, place of work, your auto or in a time of High Alert be taken with you most any place you might go. A receiver that includes many of the most important features of the Homeland Security System I envision.

FIG. 1 is a block diagram of what I envision as a Portable Homeland Security Emergency FM Receiver that could be used in the home, office, or taken anywhere you might go. #1 The antenna would be designed to favor the Homeland Security Emergency frequencies, and not the AM/FM section of the receiver. An external antenna connection would allow improved reception in locations on the fringe or even outside Homeland Security Emergency Stations normal transmission range. Beam antennas could be designed to capture even the weakest signals. #2 The tuning circuits for the Homeland Security section of the receiver would include five pushbuttons, each button selecting a separate tuning circuit designed to receive the maximum signal of each of the five different Homeland Security Emergency FM Radio station frequencies established for use with such a system. The tuning section would include all signal processing circuits necessary to include #2A, Auto/Search Tuning, as well as circuits that would indicate #2B Channel Signal Strength. It would include #9 FM/AM Blocking circuits that would block any AM/FM programming being played when an Emergency Warning or Alert transmission was received on the Left Stereo Channel. These Blocking circuits would allow Homeland Security Warnings and Alerts to be passed on to the amplification circuits and the speaker. Normally, the Left/Right Stereo switch shown in FIG. 2 would be set and remain in the Left position. This would assure that the user would receive Homeland Security Warning and Alert messages even if he had the FM or AM section turned ON and playing commercial programming. Anytime the user selects the Right stereo channel to receive Homeland Security News and Information messages, the dual section switch would also disrupt the output of the AM-FM section of the receiver, assuring that he would not hear Homeland Security News and Information messages as well as programming being received from the AM-FM section at the same time. The #2A Auto/Search circuits would seek and select the channel with the strongest available signal of the five channels. This feature would be particularly useful when traveling through different Homeland Security transmission areas. A switch would allow Auto/Search to be disabled and returned to normal push button tuning. #2B Signal Strength circuits would be included with a separate light for each channel. When a signal being received reached a pre-established level, the light for that channel would light up. Say that you are traveling between or close to two or more different Homeland Security station areas. Even without knowing their individual frequencies, just by glancing down at the lights you would know which station push buttons were receiving sufficient signal strenth to receive Homeland Security Emergency transmissions. #5 The Blocking circuits that would be necessary to block the daily 30 second transmission for tunning and setting the volume would require an additional sub-carrier signal be transmittered by the Homeland Security Emergency FM Radio transmitter for this purpose. Such blocking circuits would allow the receiver to remain totally silent 24 hours a day even when the 30 second transmission was being broadcast for tunning and setting the volume. The 30 second transmission would be continued after Phase 2 went into effect even though the push-button tuning circuits assured accurate tuning. The 30 second signal would continue to be used to determine if the receiver was operating properly and allow the user to manually set the volume of the Left Stereo Channel to establish a volume level that would be heard in the event of an Homeland Security Warning or Alert. To establish the desired volume level (See FIG. 2) the user would first turn the HD Volume switch ON, then set the desired volume level using the main volume control, then turn the HD Volume switch OFF. This only adjusts the volume level of the Left Stereo Channel, the channel carrying Homeland Security Warnings and Alerts. The volume level of the Right Channel is adjusted using the main volume control any time the Right Channel is selected. #7 The Automatic Volume Control circuits are only included to assure that the receiver will reach and not exceed predetermined dB levels when first put into use. The desired volume level for the Homeland Security Warning and Alert section can later be adjusted using the 30 second tuning transmission as described above. The name of the 30 second transmission would be changed to Test Transmission, as tuning would no longer be required in Phase 2 Homeland Security receivers. #6 When the Stereo Channel Switch was set to the Right Channel, the Informtion Channel, it would block signals from the Left Stereo Channel, the Warning and Alert Channe from being received at the same time. #3 The “Condition Threat” light circuits and necessary hardware would allow the user, by just noting the color of the light being illuminated, to instantly be informed as to the “Alert Condition” currently in effect by the Department of Homeland Security. Such a feature would also require that the Homeland Security Emergency Transmitter transmit a sub-carrier signal capable of controlling the necessary circuits in the receiver to illuminate the current “Alert Color” in effect. #4 The FM/AM tuner section would be no different than those being used in FM stereo clock radios and FM stereo portables in use today. As the receiver being described in FIG. 1 & 2 is designed to be portable, it would seem advantageous to be able to receive commercial FM and AM stations in the event the user was out of range of any Homeland Security Emergency FM Radio Station or if, for some reason, the closest Homeland Security station was off the air. Aside from that, the user might wish to listen to Local News or music programming, knowing that any Homeland Security Warning or Alert transmission would override any AM-FM programming he might be listening to. Although the Homeland Security receiver I envision FIG. 2 only shows one speaker, it could have two speakers and audio amplification sections enabling stereo reception of music from the FM/AM section of the receiver. The AC/DC power supply (#11) is conventional with the exception that it would automatically switch to DC (battery) in the event AC power was disrupted. If for some reason AC power was not being received or had been disrupted, a small RED light would come on indicating that the receiver was being powered by DC battery power. That the receiver would only remain ON for the life of the batteries. A second Yellow light would indicate that battery life was nearing exhaustion. The #10 circuits necessary to include modem capability would be little different than those found in present day notebook computers other than for being driven by FM modulation. An ON/OFF switch, as shown on FIG. 1 & 2, would activate the necessary modem circuits. Having totally separate circuits for the Homeland Security receiver section, the AM/FM radio section and the digital modem section, any or all of these sections could be functioning at the same time. As many Homeland Security receivers would likely be in use before Phase 2 was put into effect, all features I suggested could immediately put to use, with the exception of taking advantage of both the left and right stereo channels.

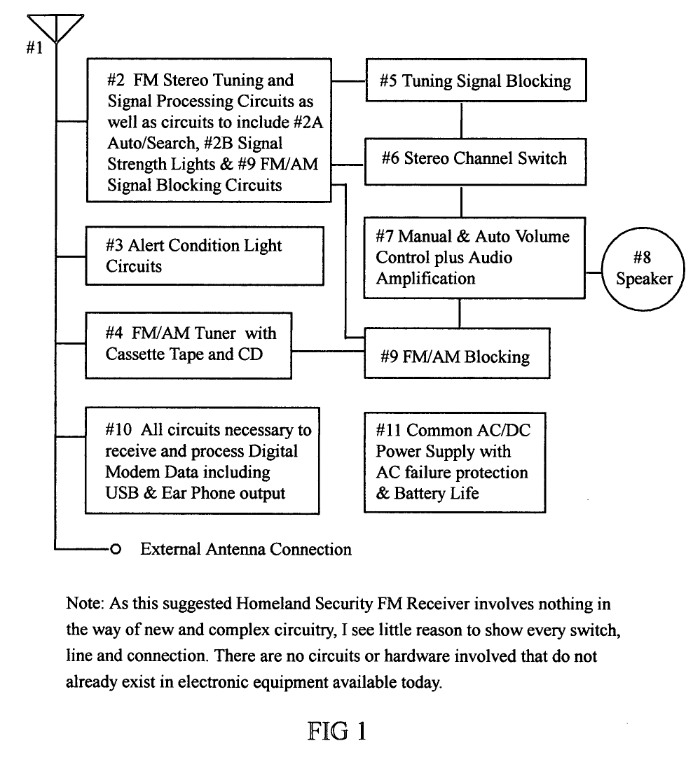

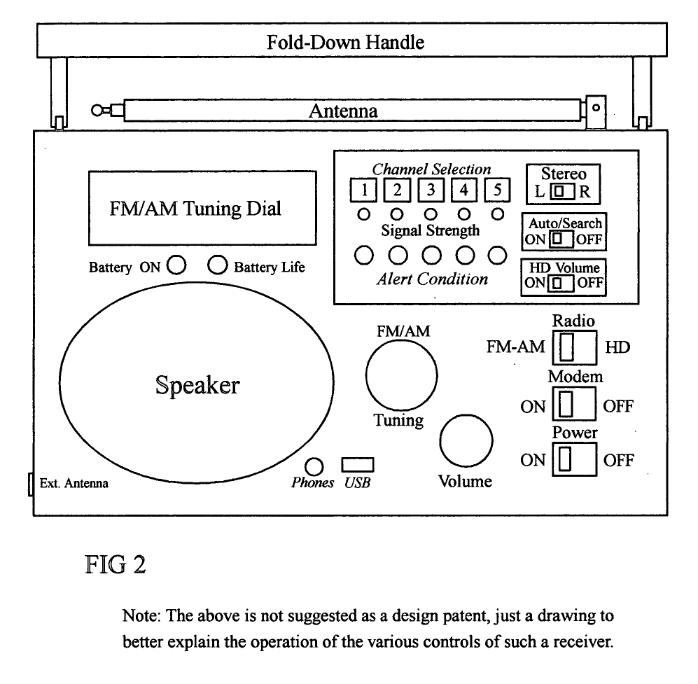

Naturally, any or all of the above capabilities could be designed into present day FM portable, clock radios, Auto Radios, FM tuners, Walkman type radios, and even TV sets, as well as high end full featured receivers for Government and specialized use. FM Radios with cassette tape decks, CD and MP3, players could also include Homeland Security Emergency receiver sections.

All circuitry that would be required to design and manufacture the homeland security FM Reciever described above can be found in various electronic devices such as auto radios, boom boxes, clock radio, computers, etc.

1. A Homeland Security Emergency FM receiver that is totally silent 24 hours a day, day after day, unless an Emergency Warning or Alert is transmitted by a Homeland Security Emergency FM Radio System I envision.

2. A Homeland Security Emergency FM receiver that takes advantage of both the left and right stereo channels, the left stereo channel for Homeland Security Emergency Warning and Alert transmissions, and the right stereo channel for emergency information and instructions following a terrorist attack, as well as for Daily Homeland Security Local and National News and General Information Programs at all other times.

3. A Homeland Security Emergency FM receiver that includes colored lights that indicate the present “Terrorist Alert Condition,” a system already in use by the Department of Homeland Security.
